(19) United States
(12) Patent Application Publication
(10) Pub. No.: US 2017/0150222 A1
(43) Pub. Date: May 25, 2017

(54) APPRATUS FOR AUDIENCE MEASUREMENT ON MULTIPLE DEVICES AND METHOD OF ANALYZING DATA FOR THE SAME

(71) Applicant: Electronics and Telecommunications Research Institute, Daejeon (KR)

(72) Inventors: Sang Wan KIM, Daejeon (KR); Dong Won KANG, Daejeon (KR); Ki Dong NAM, Daejeon (KR)

(73) Assignee: Electronics and Telecommunications Research Institute, Daejeon (KR)

(21) Appl. No.: 15/355,434

(22) Filed: Nov. 18, 2016

(30) Foreign Application Priority Data
Nov. 19, 2015 (KR) 10-2015-0162531
May 24, 2016 (KR) 10-2016-0063718

(51) Int. Cl. H04N 21/466; H04N 21/431; H04N 21/433; H04N 21/435; H04N 21/858; H04N 21/422; H04N 21/442; H04N 21/482

(52) U.S. Cl. CPC H04N 21/4667; H04N 21/44222; H04N 21/4312; H04N 21/482; H04N 21/435; H04N 21/8586; H04N 21/42204; H04N 21/433

(57) ABSTRACT

Apparatuses for audience measurement on various user devices and data analysis methods for audience measurement on various user devices are disclosed. An audience measurement apparatus in an N-screen environment may comprise a gathering part configured to collect viewing data including screen images captured from a viewing device and time information on times at which the screen images are captured; and an analysis part configured to obtain information necessary for audience measurement by analyzing the collected viewing data.

### CLAIM FOR PRIORITY

This application claims priorities to Korean Patent Applications No. 2015-0162531 filed on Nov. 19, 2015 and No. 2016-0063718 filed on May 24, 2016 in the Korean Intellectual Property Office (KIPO), the entire contents of which are hereby incorporated by reference.

### BACKGROUND

1. Technical Field

The present invention relates to a broadcasting service technology, and more particularly, to methods of gathering and analyzing data for audience measurement in various devices.

2. Related Art

In order to perform audience measurement on fixed-type devices such as television (TV), a method of gathering and analyzing information by using people meters or set-top boxes for the fixed-type devices is used. Meanwhile, various watching attitudes using N-screen devices such as mobile communication terminals, smart TVs, or computers are increasing. In this N-screen environment, the conventional audience measurement method using the people meters or set-top boxes installed in the fixed-type devices has limitation in gathering data for the audience measurement.

As a method of gathering data for audience measurement for contents of a mobile terminal, there is a method in which audio and video data of contents being watched are collected in the mobile terminal and the collected audio and video data are compared with audio or video data of the contents which are subject to the audience measurement. However, since the audio data have various environmental noises due to characteristics of the mobile terminal, the method of recording and analyzing audio data has low accuracy in its results. Also, when an operating system of the mobile terminal does not support functions for collecting video data, the method of recording and analyzing video data cannot be used in the mobile terminal. Also, for the comparison between the collected audio and video data and the audio and video data of the original contents, a complete database for the audio and video data of the original contents being broadcasted for 24 hours should be prepared.

### SUMMARY

Accordingly, example embodiments of the present invention are provided to substantially obviate one or more problems due to limitations and disadvantages of the related art.

Example embodiments of the present invention provide apparatuses for audience measurement which can efficiently perform audience measurements on a program provided through N-screen devices such as a smart television, a computer, a mobile communication terminal, etc., and methods of analyzing data for the audience measurements.

In order to achieve the above-described objective, an aspect of the present disclosure provides an audience measurement apparatus in an N-screen environment comprising a gathering part configured to collect viewing data including screen images captured from a viewing device and time information on times at which the screen images are captured; and an analysis part configured to obtain information necessary for audience measurement by analyzing the collected viewing data.

Here, the gathering part may further collect user selection information in the captured screen images.

Also, the user selection information may include a coordinate value of a position in which a user of the viewing device performs a screen manipulation.

Here, the gathering part may collect the viewing data by identifying a viewing start time or a viewing end time based on a key input event of a user of the viewing device.

Here, when a key input event of a user of the viewing device is detected, the gathering part may capture a screen image at the time of the key input event, extract a coordinate value of a screen in which the key input event is located, and generate time information on a time at which the screen image is captured.

Here, the gathering part may collect the viewing data by identifying a viewing start time or a viewing end time based on a traffic amount change event occurring when an amount of traffic inflow to or buffered data in the viewing device is changed.

Here, when a traffic amount change event occurring when an amount of traffic inflow to or buffered data in the viewing device is changed is detected, the gathering part may generate traffic amount change trend information on the amount of traffic inflow to or buffered data in the viewing device, capture a screen image at the time of the traffic change event, and generate time information on a time at which the screen image is captured.

Here, the gathering part may collect the viewing data by identifying a viewing start time or a viewing end time based on both of a key input event of a user of the viewing device and a traffic change event occurring when an amount of traffic inflow to or buffered data in the viewing device is changed.

Here, before occurrence of a viewing event, the gathering part may capture, at predetermined intervals, screen images and store the screen images and time information on times at which the screen images are captured in a temporary folder. Also, after a viewing event is detected, the gathering part may move the screen images and time information stored in the temporary folder for within a predetermined time duration from the detection of the viewing event to an event folder, and transmit the moved screen images and time information to the analysis part.

Here, when a viewing event in the viewing device is detected, the gathering part may capture screen images of the viewing device for a data collection duration according to a data collection cycle, store the screen images and time information on times at which the screen images are captured in an event folder, and transmit the screen images and time information to the analysis part after completion of the predetermined collection duration.

Here, when a new viewing event is detected while performing procedures for collecting and storing data according to a previous viewing event, the gathering part may stop the procedures for collecting and storing data according to the previous viewing event, and newly start a procedure for collecting and storing data according to the new viewing event.

Here, the gathering part may capture the screen images by generating capture instructions according to the data collection cycle.

Here, the gathering part may adjust the data collection duration and the data collection cycle.

Here, the analysis part may obtain at least one of uniform resource locator (URL) information, time information, information on an application used for viewing, broadcasting channel information, and program information by analyzing characters in the screen images captured in the gathering part.

Here, the analysis part may receive the traffic amount change trend information from the gathering part, and identify a viewing start time when the traffic amount change trend information shows a rapid traffic increase, and a viewing end time when the traffic amount change trend information shows a rapid traffic decrease.

In order to achieve the above-described objective, another aspect of the present disclosure provides a data analysis method for audience measurement in an N-screen environment comprising detecting a viewing event in a viewing device; when the viewing event is detected, capturing a screen image at which the viewing event is detected, and collecting viewing data including the screen image and time information on a time at which the screen image is captured; and obtaining information necessary for audience measurement by analyzing the collected viewing data.

Here, the collecting viewing data may further comprise detecting a key input event in the viewing device; capturing a screen image at the time of the key input event, and extracting a coordinate value of a position in the screen image where the key input event is located; and generating time information on a time at which the screen image is captured.

Here, the collecting viewing data may further comprise detecting a change in an amount of traffic inflow to or buffered data in the viewing device; generating traffic amount change trend information on the detected change in the amount of traffic inflow to or buffered data in the viewing device; and capturing a screen image at the time of the change, and generating time information on a time at which the screen image is captured.

Here, the obtaining information necessary for audience measurement may further comprise analyzing characters in the screen image; and obtaining at least one of uniform resource locator (URL) information, time information, information on an application used for viewing, broadcasting channel information, and program information based on results of the analysis.

Here, the method may further comprise, before occurrence of a viewing event, capturing screen images of the viewing device at predetermined intervals, and storing the captured screen images and time information on times at which the captured screen images are captured in a temporary folder; and, after the viewing event is detect, moving the captured screen images and time information stored in the temporary folder for within a predetermined time duration to an event folder.

According to the exemplary embodiments of the present disclosure, audience measurements on various N-screen viewing devices can be efficiently performed. In the conventional TV rating, a method, in which audio and video data of contents being watched are collected in the mobile terminal and the collected audio and video data are compared with audio or video data of the contents which are subject to the audience measurement, is used. However, in contrast to the conventional method, the method and apparatus proposed in the present disclosure can perform audience measurement by using only collected screen capture images and additional information without need to construct a database of original contents. Therefore, a time and cost required for generating digital information by analyzing audio and video of original contents and constructing the database for comparison can be saved.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram to explain an audience measurement system according to an exemplary embodiment of the present disclosure;

FIG. 2 is a block diagram to explain an audience measurement apparatus according to an exemplary embodiment of the present disclosure;

FIG. 3 is a flow chart to explain an audience measurement method according to an exemplary embodiment of the present disclosure;

FIG. 4 is a flow chart to explain a data collection procedure for audience measurement according to an exemplary embodiment of the present disclosure;

FIG. 5 is a flow chart to explain a data collection procedure for audience measurement according to another exemplary embodiment of the present disclosure;

FIG. 6 is a flow chart to explain a data collection procedure for audience measurement according to yet another exemplary embodiment of the present disclosure;

FIG. 7 is a conceptual view to explain a captured screen image showing viewing data which can be obtained from the captured screen image according to an exemplary embodiment of the present disclosure; and

FIG. 8 is a conceptual view to explain a captured screen image showing viewing data which can be obtained from the captured screen image according to another exemplary embodiment of the present disclosure.

### DESCRIPTION OF EXAMPLE EMBODIMENTS

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Combinations of respective blocks in an accompanying block diagram and respective operations in a flowchart may be performed by computer program instructions. These computer program instructions can be mounted on a processor of a general purpose computer, a special purpose computer, or other programmable data processing equipment, and thus the instructions performed by the processor of the computer or other programmable data processing equipment generate a means for performing functions described in the respective blocks of the block diagram or the respective operations of the flowchart. To implement functions in a specific way, these computer program instructions can be stored in a computer-usable or computer-readable memory capable of aiming for a computer or other programmable data processing equipment, so that the instructions stored in the computer-usable or computer-readable memory can also produce a manufactured item including an instruction means for performing functions described in the respective blocks of the block diagram or the respective operations of the flowchart.

In addition, each block or operation may indicate a part of a module, a segment or a code including one or more executable instructions for executing specific logical function(s). It should be noted that mentioned functions described in blocks or operations can be executed out of order in some alternative embodiments. For example, two consecutively shown blocks or operations can be performed substantially at the same time, or can be performed in a reverse order according to the corresponding functions.

Hereinafter, exemplary embodiments according to the present disclosure will be described in detail by referring to accompanying drawings. However, the exemplary embodiments according to the present disclosure may be changed into various forms, and thus the scope of the present disclosure is not limited to the exemplary embodiments which will be described. The exemplary embodiments are provided to assist the one of ordinary skill in the art. in gaining a comprehensive understanding of the methods, apparatuses, and/or systems described herein.

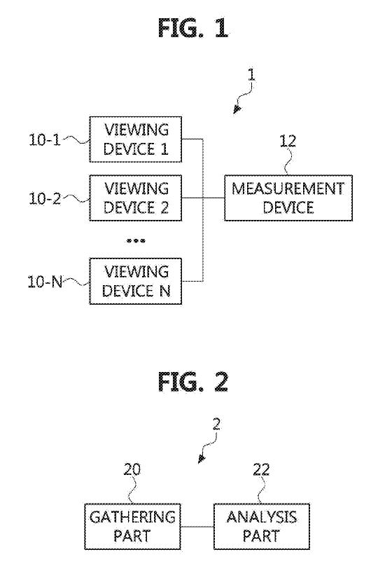

FIG. 1 is a conceptual diagram to explain an audience measurement system according to an exemplary embodiment of the present disclosure.

Referring to FIG. 1, the audience measurement system 1 may comprise a plurality of viewing devices 10-1, 10-2, . . . , 10-N, and a measurement device 12.

As N-screen services are revving up, watching attitudes using various viewing devices 10-1, 10-2, . . . , 10-N are increasing. The audience measurement system 1 may efficiently collect and analyze information for the audience measurement from the plurality of viewing devices 10-1, 10-2, . . . , 10-N which are N-screen devices.

The viewing devices 10-1, 10-2, . . . , 10-N may be various devices which user can use to watch contents. For example, the viewing devices 10-1, 10-2, . . . , 10-N may be mobile terminals, smart TVs, computers, etc. Especially, the viewing devices 10-1, 10-2, . . . , 10-N may be devices which the user can carry. The measurement device 12 may analyze various viewing data collected from the devices 10-1, 10-2, . . . , 10-N, and utilize the analyzed data as data for audience measurement. The measurement device 12 may be a server. The user may watch various contents output through at least one of the viewing devices 10-1, 10-2, . . . , 10-N. The contents may be broadcasted through a broadcasting channel.

The audience measurement system 1 according to an embodiment of the present disclosure may use a method of collecting captured images by capturing viewing screens and analyzing the captured images, not a conventional method of recording video and audio. The captured images may include various characters, and the measurement device 12 may analyze the characters in the captured images and obtain information necessary for the audience measurement. For example, URL information, time information, information on an application used for viewing, information on broadcasting channel and user-selected program, etc. may be obtained from the captured images.

The viewing devices 10-1, 10-2, . . . , 10-N may respectively capture screen images of them, and obtain time information on times at which the screen images are captured. Also, the viewing devices 10-1, 10-2, . . . , 10-N may collect additional information for audience measurement, for example, information on user selection in the captured images. For example, the information on user selection may include a position such as a touch coordinate of the user. For another example, information on changes in the amount of traffic or buffered data in the viewing devices 10-1, 10-2, . . . , 10-N may be collected.

According to an exemplary embodiment, the viewing devices 10-1, 10-2, . . . , 10-N may capture their screen images before or after occurrences of viewing events. Before occurrences of the viewing events, they may capture their screen images at predetermined intervals, and store them in a temporary folder together with time information on times at which the screen images are captured. Then, after occurrences of viewing events, they may capture screen images at the times of viewing events, and store them in an event folder, and move recent data stored in the temporary folder to the event folder. Thus, start or end of viewing can be accurately identified from the screen images captured before or after the viewing events occurring in respective viewing devices in the N-screen environment, and used as data for the audience measurement.

Also, characters included in the captured images, coordinates indicating positions in the screen which the user attempt to manipulate, times at which the screen images are captured, and information on changes in the traffic, etc. may be collected and analyzed so that information necessary for audience measurement such as channel information, application information, program information, and viewing time can be obtained.

FIG. 2 is a block diagram to explain an audience measurement apparatus according to an exemplary embodiment of the present disclosure.

Referring to FIG. 2, an audience measurement apparatus 2 may comprise a gathering part 20, and an analysis part 22. The gathering part 20 may be located in each of the viewing devices 10-1, 10-2, . . . , 10-N. The analysis part 22 may be located in the measurement device 12 of FIG. 1, or each of the viewing devices 10-1, 10-2, . . . , 10-N. The gathering part 20 and the analysis part 22 may be connected to each other via wire or wireless communication means. In this case, the gathering part 20 may transmit collected data to the analysis part 22, and the analysis part 22 may receive the collected data from the gathering part 20, and analyze the received data. Each of the gathering part 20 and the analysis part 22 may be implemented using a processor. In this case, the gathering part 20 may be implemented as a viewing data collection program, and the analysis part 22 may be implemented as a viewing data analysis program. Such the collection program and the analysis program may be stored in a memory.

The gathering part 20 according to an exemplary embodiment may collect screen images captured from the viewing devices 10-1, 10-2, . . . , and 10-N and user selection information in the captured screen images. The user selection information may include coordinates in the screen, which indicate positions at which the user attempts to manipulate.

The gathering part 20 according to an exemplary embodiment may also collect viewing data by determining start or end of viewing at occurrences of viewing events. Here, viewing event occurrence conditions may include an occurrence of key input by a user in a screen, changes (rapid increase or rapid decrease) in the amount of traffic inflow or buffered data. For example, a key input by the user to a screen may be identified as an occurrence of event. Upon detecting the user's key input event, the gathering part 20 may capture a screen image at the time of the key input, extract a coordinate value of the position at which the key input is given, and generate time information on a time at which the screen image is captured or the time of the key input.

Alternatively or additionally, the gathering part 20 may collect the viewing data by identifying a start or end of viewing at an occurrence of events such as changes in the amount of traffic inflow or buffered data. Upon detecting the changes in the amount of the traffic inflow or buffered data, the gathering part 20 may generate trend information on the amount of traffic or data, capture a screen image at the time of the detection, and generate time information on a time at which the image is captured or the event (change in the amount of the traffic or buffered data) is detected.

Alternatively or additionally, the gathering part 20 may identify start or end of viewing when both of the key input event and the changes in the amount of traffic both are satisfied. For example, when the gathering part 20 detects a key input event and detects the change in the amount of traffic inflow or buffered data based on the detected key input event, the gathering part 20 may determine that the viewing of streaming data according to the key input event starts or ends, and collect viewing data based on the determination.

According to an exemplary embodiment, before an occurrence of viewing event, the gathering part 20 may capture screen images of the viewing device at predetermined intervals, and store, in a temporary folder, the captured screen images together with time information on times at which the screen images are captured. Then, when the gathering part 20 detects the occurrence of viewing event, the gathering part 20 may move the captured images and time information, which were stored recently (e.g. within a predetermined time duration from the occurrence of the viewing event), to an event folder.

According to an exemplary embodiment, when the occurrence of event is detected in the viewing device, the gathering part 20 may capture screen images of the viewing device according to predetermined collection cycle and period, and store the captured screen images and time information at which the images are captured in the event folder. Then, when the data collection period ends from the detected occurrence of the viewing event, the gathering part 20 may transmit the viewing data stored in the event folder to the analysis part 22, thereby letting the analysis part utilize the viewing data as data for audience measurement.

According to an exemplary embodiment, when a new event occurs during the procedure of collecting and storing viewing data according to the previous event occurrence, the gathering part 20 may stop the procedure based on the previous event, and start a procedure based on the new event.

According to an exemplary embodiment, after the occurrence of the event, the gathering part 20 may monitor its image capture periods, and generate image capture instructions at every image capture period in order to capture screen images. The gathering part 20 may adjust the data collection cycle and periods.

The analysis part 22 may receive the viewing data collected through the gathering part 20, and analyze the received data to obtain data for audience measurement. According to an exemplary embodiment, the analysis part 22 may receive captured screen images from the gathering part 20, and obtain at least one of URL image, time information, application information, broadcasting channel information, and user selected program information by analyzing characters in the received screen images. For another example, the analysis part 22 may receive trend information on changes in the amount of traffic from the gathering part 20, and analyze the received trend information. When it is determined that the traffic increases rapidly, the analysis part 22 may identify a start of viewing. On the contrary, when it is determined that the traffic decreases rapidly, the analysis part 22 may identify an end of viewing.

The viewing data collection procedure of the gathering part 20 and the viewing data analysis procedure of the analysis part 22 will be explained in detail by referring to the following figures.

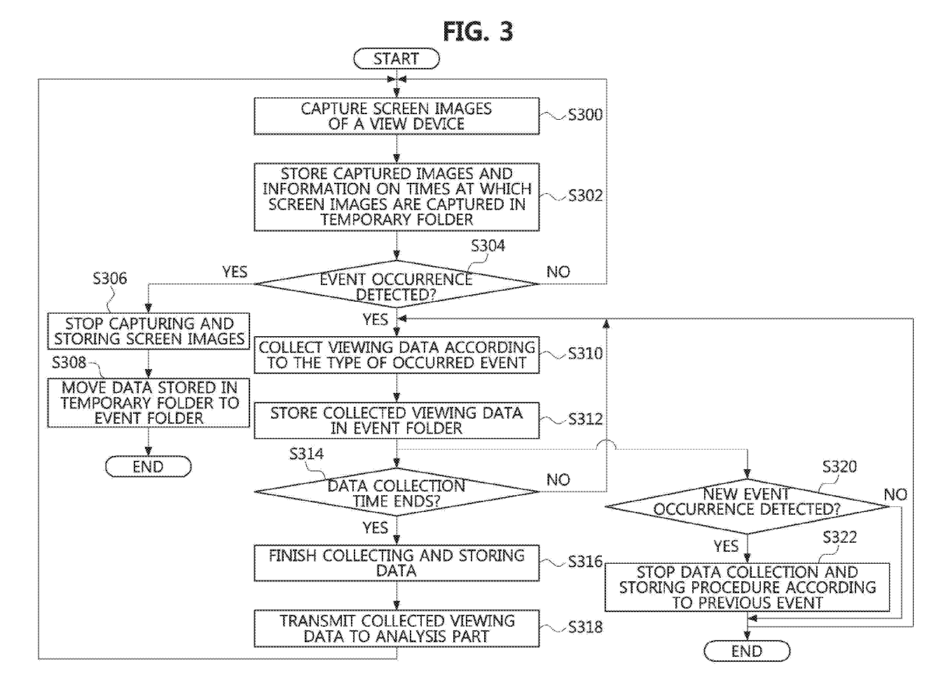

FIG. 3 is a flow chart to explain an audience measurement method according to an exemplary embodiment of the present disclosure.

Referring to FIG. 2 and FIG. 3, the gathering part 20 may collect viewing data for audience measurement in a viewing device. For the data collection, a viewing data collection program may be installed in the viewing device. The viewing data collection program may be automatically activated when the viewing device is driven, or manually activated or inactivated according to a user configuration.

The gathering part 20 may capture screen images of the viewing device before detecting an occurrence of a viewing event (S300). Here, the gathering part 20 may capture the screen images at predetermined intervals. Then, the gathering part 20 may store the captured screen images in a temporary folder (S302). The time information on times at which the screen images are captured may also be stored in the temporary folder as mapped to the captured screen images. In consideration of storage capacity of the temporary folder, the captured images and time information may be stored in the temporary folder in a first-in first-out (FIFO) manner in which old data are overwritten by new data.

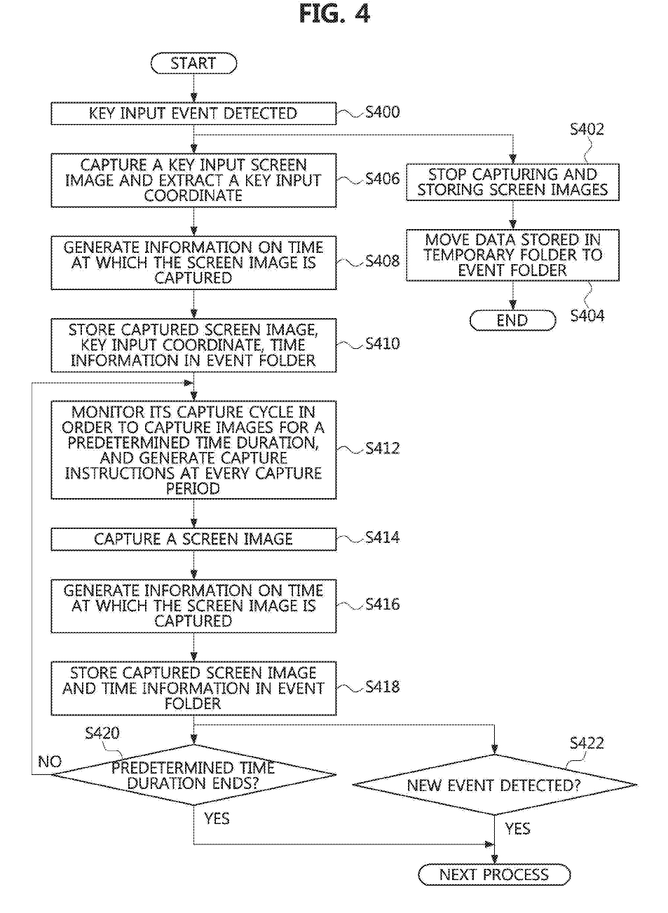

While performing the procedure of capturing and storing screen images, if the occurrence of the event is detected (S304), the gathering part 20 may stop the procedure of capturing and storing images (S306), and move captured images and time information on times at which the images are captured which were stored recently (i.e. stored within a predetermined time duration from the occurrence of the event) to an event folder (S308). Upon detecting the occurrence of the event, the gathering part 20 may also perform a predetermined procedure of data collection according to a type of the occurred event (S310). For example, a procedure for collecting data for audience measurement such as image capture and generation of time information may be performed according to a predetermined cycle and period. The procedure for collecting data according to the type of occurred event will be explained referring to FIGS. 4 to 6.

Then, the gathering part 20 may store the collected viewing data in the event folder (S312). Here, the images captured after the occurrence of the event may be stored in the event folder as mapped to the time information included in the captured images. Then, it is identified whether a predetermined time duration for the date collection elapses from the occurrence of the event (S314). If the predetermined time duration does not end, the procedure of collecting data may be repeatedly performed according to the set periodicity (S310). If the predetermined time is expired, the procedure of collecting and storing data may be finished (S316).

Then, the gathering part 20 may transmit the viewing data including the captured images and time information stored in the event folder to the analysis part 22 (S318) so that the data can be utilized as data for audience measurement. After completion of the procedure of collecting viewing data and transmitting the data to the analysis part 22 based on the detection of the event, the procedure of periodically capturing images and storing captured images in the temporary folder may be resumed (S300). If a new event occurs (S320) during the data collection procedure (S310) and the data storing procedure (S312), the procedures S310 and S312 according to the previous event may be stopped (S322), and a data collection procedure according to the new event may be newly started (S310).

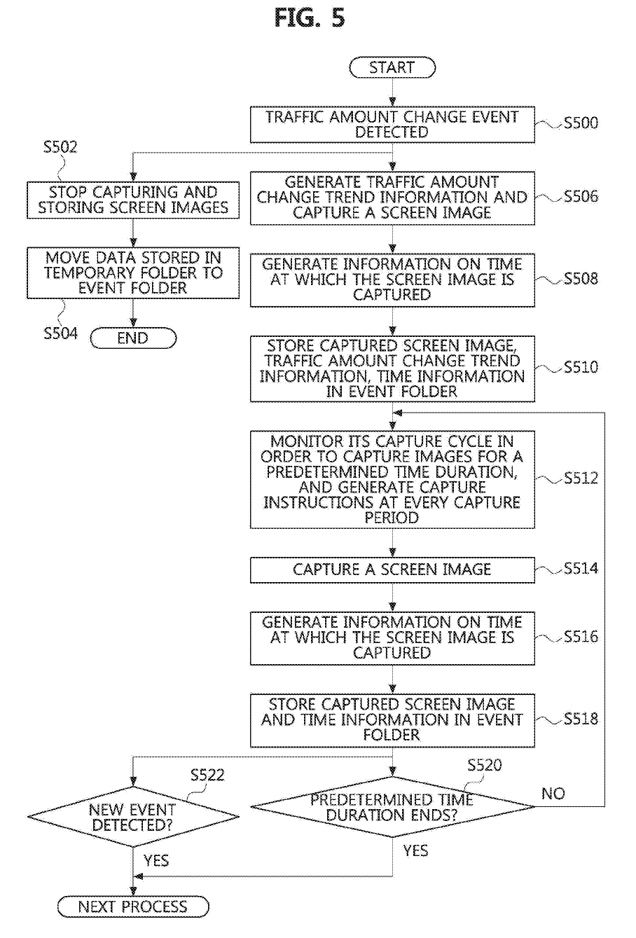

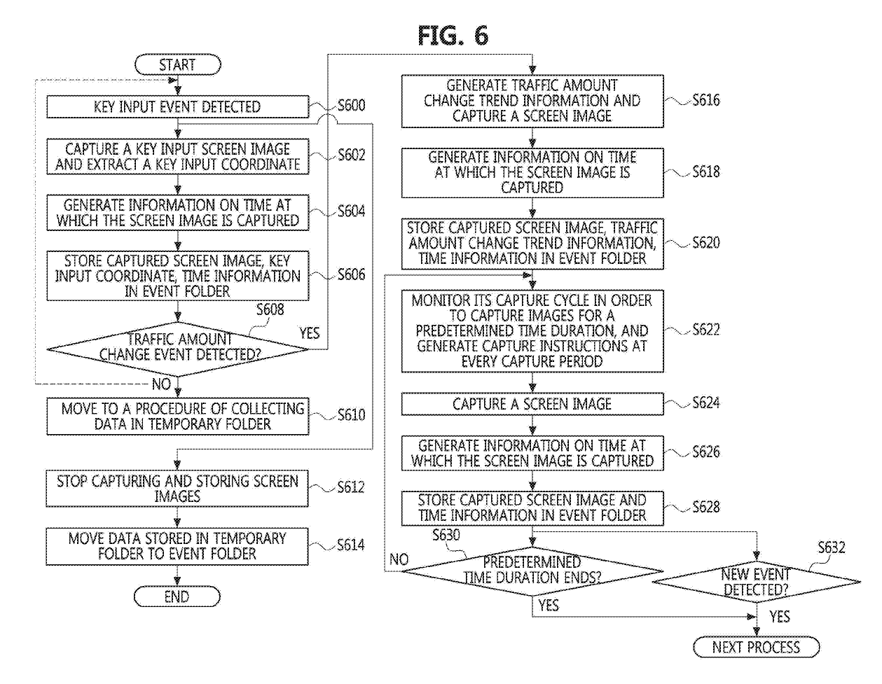

The event occurrence conditions for audience measurement in various viewing devices may be variously defined. In the present disclosure, they may be classified into events through user key inputs, and events based on changes in the traffic such as introduction of streaming data or end of streaming data. FIG. 4 illustrates a data collection procedure for audience measurement when a user key input event occurs, FIG. 5 illustrates a data collection procedure for audience measurement when an event based on changes in the traffic occurs, and FIG. 6 illustrates a data collection procedure for audience measurement when a user key input event and an event based on changes in the traffic both occur.

FIG. 4 is a flow chart to explain a data collection procedure for audience measurement according to an exemplary embodiment of the present disclosure.

Referring to FIG. 2 and FIG. 4, the gathering part 20 may detect a user's key input event (S400). The key input event may be, for example, a user's touch on a screen, a mouse click, or manipulation of a remote controller. Through the key input event, a start or end of viewing can be identified.

Upon detecting the key input event (S400), the gathering part 20 may stop the procedure of capturing images and storing the captured images in the temporary folder (S300 and S302 of FIG. 3) (S402), and move images captured and stored before the detection of the key input event to the event folder (S404). Also, the gathering part 20 may capture a screen image where the key input event occurs, extract position information including a coordinate value at which the user manipulates in the captured screen image (S406), and generate time information at which the screen image is captured (S408). Then, the gathering part 20 may store the position information and the captured screen image at the time at which the key input event occurred in the event folder (S410). Through this, data indicating that the user manipulated the screen at the start or end of viewing can be obtained.

After the detection of the key input event, the gathering part 20 may monitor its capture cycle in order to capture images for a predetermined time duration, and generate capture instructions at every capture period (S412). Then, images are captured (S414), time information on times at which the images are captured are generated (S416), and collected information including the captured images and the time information may be stored in the event folder (S418). Here, the time information may be stored in the event folder as mapped to the captured images.

Then, the gathering part 20 may identify whether the predetermined time duration elapses from the time at which the key input event occurred (S420). When the predetermined time duration does not end, the data collection procedures are performed repetitively (S412 to S420). On the contrary, when the predetermined time duration ends, the data collection procedure may be stopped. After the data collection procedure ends, data collected in the event folder are transmitted to the analysis part 22, and the procedure of periodically capturing images and storing the captured images in the temporary folder may be resumed. Also, while performing the data collection procedure according to the occurrence of the event, if a new event is detected (S422), the data collection procedure according to the previous event may be stopped, and a data collection procedure according to the type of the new event may be newly started.

Through this, screen images captured around times at which the user attempted to start or end viewing by key input events, coordinate values according to the screen manipulation, and time information at which the screen images were captured may be collected, and utilized as data for audience measurement.

FIG. 5 is a flow chart to explain a data collection procedure for audience measurement according to another exemplary embodiment of the present disclosure.

Referring to FIG. 2 and FIG. 5, the gathering part 20 may monitor a trend of the amount of traffic inflow or buffered data in the viewing device, and detect an event at which the trend changes. The change in the amount of traffic inflow or buffered data may mean a start or end of viewing. For example, when a user starts viewing a streaming broadcasting, the amount of traffic inflow or buffered data may rapidly increase by more than a predetermined amount at the start of viewing. On the contrary, when the broadcasting ends intentionally according to the user's key input or ends unintentionally according to a change of network environment without the user's key input, the amount of traffic inflow or buffered data may rapidly decrease. Thus, the gathering part 20 may identify the time at which the amount of traffic inflow or buffered data rapidly increases or decreases as an occurrence time of an event.

Upon detecting the event at which the amount of traffic inflow or buffered data rapidly changes (S500), the gathering part 20 may store images captured around the occurrence of the event, time information on times at which the images are captured, and trend information on the change in the amount of traffic in the event folder. Through the captured images and time information, still images of contents being watched by the user at the start or end of viewing, and related time information may be obtained. Also, through the trend information, a start time of viewing (rapid increase of the amount of traffic) and an end time of viewing (rapid decrease of the amount of traffic) may be identified.

The gathering part 20 may monitor the amount of traffic inflow or buffered data, and identify an occurrence of an event by detecting whether a change more than a predetermined threshold occurs in the amount of traffic inflow or buffered data (S500). When the event is identified to occur, the procedure of collecting data in the temporary folder may be stopped (S502), and move captured images and time information stored in the temporary folder to the event folder (S504).

Also, the gathering part 20 may generate traffic amount change trend information on rapid changes in increase or decrease of the amount of traffic inflow after the occurrence of the event (occurrence of traffic amount change) (S506). The traffic amount change trend information may be used for identifying a start time of viewing (rapid increase of traffic amount) or an end time of viewing (rapid decrease of traffic amount) by the analysis part 22. Also, the gathering part 20 may capture a screen image at the time of the event occurrence (S506). Also, the gathering part 20 may generate time information on a time at which the screen image is captured (S508), thereby storing the screen captured image and the generated traffic amount change trend information in the event folder (S510).

In order to capture images during a predetermined time after detection of the event, the gathering part 20 may monitor its capture cycle and generate additional capture instructions at predetermined captured periods (S512). Also, the gathering part 20 may capture images (S514), generate time information on times at which the images are captured (S516), and store collected viewing data including the captured images and the time information in the event folder (S518). Here, the time information may be stored in the event folder as mapped to the corresponding captured image.

Then, it is determined whether the predetermined time for the data collection procedure elapses after the event occurrence (S520). When the predetermined time duration does not end, the data collection procedure may be performed repetitively (S512 to S520). On the contrary, when the predetermined time duration ends, the data collection procedure may be finished (S316 of FIG. 3). After the data collection procedure ends, the data collected in the event folder may be transmitted to the analysis part 22 (S318 of FIG. 3), and the procedure of periodically capturing images and storing them in the temporary folder may be resumed (S300 of FIG. 3). If a new event is identified to occur while performing the data collection procedure according to the event occurrence (S522), the procedure for collecting and storing data according to the previous event may be stopped (SS322 of FIG. 3), and a data collection procedure according to the type of the new event may be newly started (S310 of FIG. 3).

Through this, the gathering part 20 may obtain images at which the user starts or ends the viewing, and time information for the images by storing images in the event folder, according to a predetermined cycle, around time points when the amount of traffic inflow or buffered data rapidly changes (e.g. when the amount of traffic or buffered data rapidly increases or decrease).

In order to reduce the amount of data which the gathering part 20 collects and transmits to the analysis part 22, combinational conditions for collecting data according to occurrences of events may be used. When a viewing starts or ends by a key input event, the amount of traffic inflow or buffered data may rapidly increase or decrease according to the start or end of the viewing. Also, usual data generated by usual key input events not for viewing may have different data characteristics from the data for streaming. For example, traffic for streaming may have characteristics that the traffic amount rapidly increases at the start point, the traffic amount remains constantly, and the traffic data are buffered. Using such the various traffic characteristics of the streaming traffic, the traffic for streaming and other types of traffic may be discriminated. That is, only the traffic generated after a key input event and showing characteristics of the streaming traffic may be regarded as the traffic according to the occurrence of the event.

FIG. 6 is a flow chart to explain a data collection procedure for audience measurement according to yet another exemplary embodiment of the present disclosure. Specifically, FIG. 6 illustrates a data collection procedure using combinational data collection conditions according to events.

Referring to FIG. 6, a key input event may be detected (S600), a procedure for collecting data in a temporary folder may be stopped (S612), and images during a predetermined time just before the detected event stored in the temporary folder to an event folder (S614). Also, the gathering part 20 may extract a coordinate value at which the user manipulates a screen (S602), generate time information on a time at which an image is captured (S604), and store the image captured at the time of the event and position information including the coordinate value (S606).

Then, in the case that a change more than a threshold is identified to occur in the amount of traffic inflow or buffered data while monitoring the traffic inflow or buffered data, the gathering part 20 may determine occurrence of an event (S608). However, when the event according to the change in the amount of traffic flow does not occur, the gathering part 20 may collect data at predetermined intervals through the procedure of periodically collecting data in the temporary folder (S610). This procedure may be performed through the procedure of periodically capturing screen images of a viewing device and storing the captured images in the temporary folder which was explained referring to FIG. 3. If the data collected through the data collection procedure storing data in the temporary folder are not necessary, when an event according to a rapid change in the traffic inflow does not occur, the gathering part 20 may be in a stand-by state by transitioning to the process of detecting a key input event occurrence without performing the procedure of collecting data in the temporary folder (S610). This is illustrated with a dotted line in FIG. 6.

In a case that an event according to a change in the traffic inflow is detected, the gathering part may identify that an event of start or end of streaming according a key input event occurs (S608). Then, the gathering part 20 may generate traffic amount change trend information indicating a rapid traffic increase or a rapid traffic decrease after the occurrence of the event (i.e. after the change in the traffic amount) (S616). The traffic amount change trend information may be used for the analysis part 22 to identify a viewing start time (rapid traffic increase) and a viewing end time (rapid traffic decrease). Also, the gathering part 20 may capture a screen image at a time at which the event occurs (S616). The gathering part 20 may store the traffic amount change trend information and time information on the time at which the image is captured in the event folder as mapped to the captured image (S620).

After the detection of the event, the gathering part 20 may monitor its image capture periods, and generate additional capture instructions at every image capture period in order to capture screen images during a predetermined time (S622). The gathering part 20 may additionally capture images (S624), generate time information on times at which the images are captured (S626), and store the captured images and the time information in the event folder (S628). Here, the time information may be stored in the event folder as mapped to the captured images.

Then, it is identified whether the predetermined time duration for the data collection procedure elapses from the time at which the event occurred (S630), and the data collection procedure may be performed repetitively if the predetermined time does not end (S622 to S630). If the predetermined time duration ends (S630), the data collection procedure may be stopped. After the end of the data collection procedure, the data collected in the event folder may be transmitted to the analysis part 22, and the procedure for periodically capturing image and storing the captured images in the temporary folder may be resumed. However, if the procedure for collecting data in the temporary folder is not necessary, the procedure for collecting data in the temporary folder may be skipped. When a new event occurrence is detected while performing the data collection procedure according to event occurrence (S632), the procedure for collection and storing data according to the previous event may be stopped, and a new data collection procedure according to the new event may be newly started.

Determining whether to collect data by analyzing a trend of changes in the amount of traffic inflow or buffered data as well as key input events, data collection may be restricted only when it is determined that a start or end of watching is initiated by a key input event. Through this, the amount of data stored in the event folder may remain as minimum.

In addition, the gathering part 20 may flexibly control the data collection cycle and period according to event occurrences thereby controlling the amount of data which can be obtained. When the data collection period according to event occurrences is configured to be short, data just after the event occurrence may be collected and the amount of collected data may be minimized. On the contrary, when a large amount of data are required for analysis, the data collection period may be configured to be longer and the data collection cycle may be configured to be short so that a large amount of data can be collected after the event occurrence. Also, if the data collection end time is configured to be unlimited, data may be collected continuously before a new event is detected. In other words, data may be continuously collected until a viewing end event occurs after a viewing start event occurred.

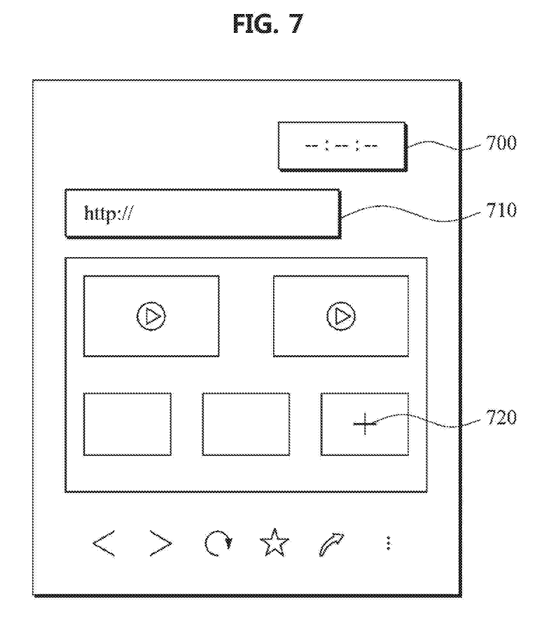

FIG. 7 is a conceptual view to explain a captured screen image showing viewing data which can be obtained from the captured screen image according to an exemplary embodiment of the present disclosure.

Referring to FIG. 2 and FIG. 7, the analysis part 22 may obtain data for audience measurement for respective viewing devices from screen capture images transmitted form the respective viewing devices. For example, a screen capture image transmitted based on a key input event may include a coordinate value 720 which a corresponding user manipulated a screen to start viewing. Thus, through this, the analysis part 22 may analyze a viewing channel and a program on which the user started or ended viewing. The analysis part 22 may obtain the user's selection information by analyzing information within a predetermined area around a position indicated by the coordinate value 720 in the screen image. In addition, the analysis part 22 may obtain additional information necessary for audience measurement by identifying URL information 710 and/or time information 700 from the received capture image.

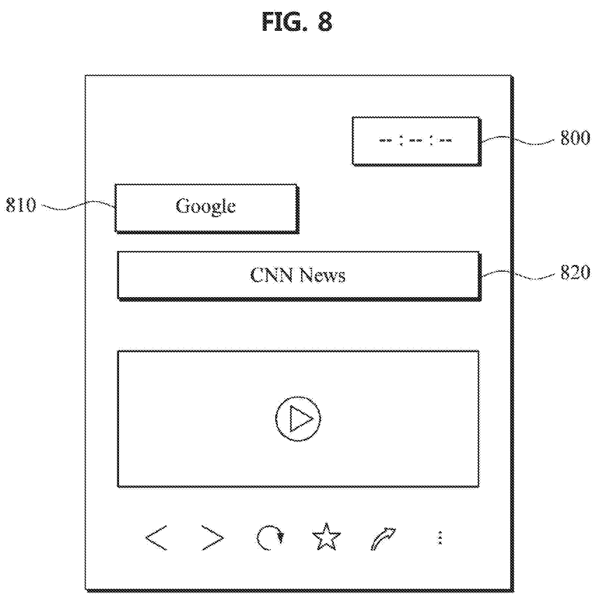

FIG. 8 is a conceptual view to explain a captured screen image showing viewing data which can be obtained from the captured screen image according to another exemplary embodiment of the present disclosure.

Referring to FIG. 2 and FIG. 7, the analysis part 22 may obtain information on an application used for viewing 810, broadcasting channels, programs 820 selected by users, and viewing time information 800 from screen capture images transmitted based on occurrences of events according to changes in the amount of traffic inflow or buffered data. Also, the analysis part 22 may identify viewing start times or viewing end times by using the capture time information, the traffic amount change trend information, and the corresponding screen captured images. The screen image captured when the traffic inflow rapidly increased may be used for identifying the viewing start time, and the screen image captured when the traffic inflow rapidly decreased may be used for identifying the viewing end time. Through this, viewing times for respective programs may be identified.

In order to analyze content by using still images, various techniques for image analysis may be used. For example, character recognition techniques such as optical character recognition (OCR) may be used for recognizing characters (e.g. URI, channel information, application information, time information, and program information) included in captured images so that information on viewing channels, viewing applications, and viewing programs, and additional time information can be identified.

As another method for analyzing captured images, digital information of a captured image may be generated by using a still image transmitted from the analysis part 22, and compared with digital information of a still image generated by using an original content so that data for audience measurement can be obtained. The above method may be used in addition to the method using character recognition so that accuracy and reliability of analysis can be enhanced.

In addition, various techniques for performing image analysis on captured images may be used for analyzing data for audience measurement. In the present disclosure, various embodiments are not restricted to a specific technique of analyzing still images.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An audience measurement apparatus in an N-screen environment, the apparatus comprising:
a gathering part configured to collect viewing data including screen images captured from a viewing device and time information on times at which the screen images are captured; and
an analysis part configured to obtain information necessary for audience measurement by analyzing the collected viewing data.

2. The apparatus according to claim 1, wherein the gathering part further collects user selection information in the captured screen images.

3. The apparatus according to claim 2, wherein the user selection information includes a coordinate value of a position in which a user of the viewing device performs a screen manipulation.

4. The apparatus according to claim 1, wherein the gathering part collects the viewing data by identifying a viewing start time or a viewing end time based on a key input event of a user of the viewing device.

5. The apparatus according to claim 1, wherein, when a key input event of a user of the viewing device is detected, the gathering part captures a screen image at the time of the key input event, extracts a coordinate value of a screen in which the key input event is located, and generates time information on a time at which the screen image is captured.

6. The apparatus according to claim 1, wherein the gathering part collects the viewing data by identifying a viewing start time or a viewing end time based on a traffic amount change event occurring when an amount of traffic inflow to or buffered data in the viewing device is changed.

7. The apparatus according to claim 1, wherein, when a traffic amount change event occurring when an amount of traffic inflow to or buffered data in the viewing device is changed is detected, the gathering part generates traffic amount change trend information on the amount of traffic inflow to or buffered data in the viewing device, captures a screen image at the time of the traffic change event, and generates time information on a time at which the screen image is captured.

8. The apparatus according to claim 1, the gathering part collects the viewing data by identifying a viewing start time or a viewing end time based on both of a key input event of a user of the viewing device and a traffic change event occurring when an amount of traffic inflow to or buffered data in the viewing device is changed.

9. The apparatus according to claim 1, wherein,
before occurrence of a viewing event, the gathering part captures, at predetermined intervals, screen images and store the screen images and time information on times at which the screen images are captured in a temporary folder; and
after a viewing event is detected, the gathering part moves the screen images and time information stored in the temporary folder for within a predetermined time duration from the detection of the viewing event to an event folder, and transmits the moved screen images and time information to the analysis part.

10. The apparatus according to claim 1, wherein, when a viewing event in the viewing device is detected, the gathering part captures screen images of the viewing device for a data collection duration according to a data collection cycle, stores the screen images and time information on times at which the screen images are captured in an event folder, and transmits the screen images and time information to the analysis part after completion of the predetermined collection duration.

11. The apparatus according to claim 10, wherein, when a new viewing event is detected while performing procedures for collecting and storing data according to a previous viewing event, the gathering part stops the procedures for collecting and storing data according to the previous viewing event, and newly starts a procedure for collecting and storing data according to the new viewing event.

12. The apparatus according to claim 10, wherein, the gathering part captures the screen images by generating capture instructions according to the data collection cycle.

13. The apparatus according to claim 10, wherein the gathering part adjusts the data collection duration and the data collection cycle.

14. The apparatus according to claim 1, wherein the analysis part obtains at least one of uniform resource locator (URL) information, time information, information on an application used for viewing, broadcasting channel information, and program information by analyzing characters in the screen images captured in the gathering part.

15. The apparatus according to claim 7, wherein the analysis part receives the traffic amount change trend information from the gathering part, and identifies a viewing start time when the traffic amount change trend information shows a rapid traffic increase, and a viewing end time when the traffic amount change trend information shows a rapid traffic decrease.

16. A data analysis method for audience measurement in an N-screen environment, comprising:
detecting a viewing event in a viewing device;
when the viewing event is detected, capturing a screen image at which the viewing event is detected, and collecting viewing data including the screen image and time information on a time at which the screen image is captured; and
obtaining information necessary for audience measurement by analyzing the collected viewing data.

17. The method according to claim 16, wherein the collecting viewing data further comprises:
detecting a key input event in the viewing device;
capturing a screen image at the time of the key input event, and extracting a coordinate value of a position in the screen image where the key input event is located; and
generating time information on a time at which the screen image is captured.

18. The method according to claim 16, wherein the collecting viewing data further comprises:
detecting a change in an amount of traffic inflow to or buffered data in the viewing device;
generating traffic amount change trend information on the detected change in the amount of traffic inflow to or buffered data in the viewing device; and
capturing a screen image at the time of the change, and generating time information on a time at which the screen image is captured.

19. The method according to claim 16, wherein the obtaining information necessary for audience measurement further comprises:
analyzing characters in the screen image; and
obtaining at least one of uniform resource locator (URL) information, time information, information on an application used for viewing, broadcasting channel information, and program information based on results of the analysis.

20. The method according to claim 16, further comprising:
before occurrence of a viewing event, capturing screen images of the viewing device at predetermined intervals, and storing the captured screen images and time information on times at which the captured screen images are captured in a temporary folder; and
after the viewing event is detect, moving the captured screen images and time information stored in the temporary folder for within a predetermined time duration to an event folder.
